(19) United States
(12) Patent Application Publication
(10) Pub. No.: US 2022/0239998 A1
(43) Pub. Date: Jul. 28, 2022

(54) HEADPHONE EAR PAD TO OPTIMIZE COMFORT AND MAINTAIN SOUND QUALITY

(71) Applicant: Sony Interactive Entertainment LLC, San Mateo, CA (US)

(72) Inventors: Sarah Karp, Foster City, CA (US); John Charles Zarganis, San Mateo, CA (US)

(21) Appl. No.: 17/161,130

(22) Filed: Jan. 28, 2021

(51) Int. Cl. H04R 1/10; B33Y 80/00; B33Y 50/00; G05B 19/4099

(52) U.S. Cl. CPC H04R 1/1008; H04R 1/1058; B33Y 80/00; G05B 2219/49023; G05B 19/4099; G05B 2219/35134; B33Y 50/00

(57) ABSTRACT

An ear pad for a headphone is made in an example technique by 3D printing. The ear pad has a lattice structure to reduce heat buildup by facilitating heat transfer through the lattice. Moreover, the lattice contours to the head of a user with an even pressure distribution to prevent or mitigate discomfort. The ear pad may achieve this by having non-uniform cushioning properties.

### FIELD

The application relates generally to headphone ear pads.

### BACKGROUND

Headphones are an important part of many audio applications including computer gaming. As understood herein, many users experience discomfort problems, and in the most extreme cases users cut their games short because of this.

As further understood herein, part of the problem stems from using, for headphone ear cups, materials that are usually optimized to achieve goals other than comfort do not always fit every user and can sometimes result in an uncomfortable headset with the combination of foam and cloth/leather covering. The most common discomfort factors reported are heat and pressure discomfort.

### SUMMARY

Present principles provide an ear pad structure to minimize these discomforts and, for example, allow gamers to play longer by targeting the key sources of gaming discomfort via the creation of a new latticed material structure. For heat discomfort, users will often complain of feeling “too hot” or “too sweaty.” The primary reason for this discomfort is the humidity and heat-trapping nature of conventional materials, such as foam and polyurethane. Through a carefully designed lattice structure, present principles reduce the heat buildup by creating a custom lattice to facilitate heat transfer. For pressure discomfort, users will often report “pressure on top of the head” a “squeezing pressure” on the sides of the head, or a “pinching” feeling. Present principles provide a lattice that contours to the head of a user with an even pressure distribution to prevent or mitigate these discomforts, rendering an optimal ear pad for the over-the-ear listening experience, with a novel material profile and lattice structure optimizing for sound and comfort simultaneously. An outer layer structure such as Polyurethane or cloth may be combined with an inner layer lattice structure made of foam or gel.

Accordingly, a device includes an ear pad for a head-worn apparatus that in turn includes an annular lattice establishing a body having a variable resistance to compression in at least one dimension defined by the lattice.

The dimension may be a radial dimension defined by the annular lattice, an axial dimension, or both.

In some examples a first segment of the ear pad has a first thickness in an axial dimension and a second segment of the ear pad has a second thickness in the axial dimension. The first segment can transition smoothly without discontinuities in thickness to the second segment.

The lattice may be an irregular lattice, or it may be a regular lattice.

The perimeters of lattice strands may define openings of different sizes. Likewise, the strands may define widths of different sizes.

In an example embodiment, the body has an inner annular surface, and the device can include a skin covering the inner annular surface.

In another aspect, a method includes generating a primitive shape of an ear pad using computer aided design (CAD), and based at least in part on the primitive shape, creating a lattice to establish at least a body of the ear pad.

In another aspect, an assembly includes at least one head-worn support and left and right ear pads on the support for cushioning a user around ears of the user when the user wears the head-worn support. The ear pads have variable compressive properties.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 illustrates a headset configured as headphones with ear pads consistent with present principles;

FIG. 2 illustrates an ear pad showing the lattice;

FIG. 3 is a side profile view of the ear pad in FIG. 2;

FIG. 4 illustrates an ear pad showing the lattice and an inner skin covering the annular inside surface of the lattice;

FIG. 5 illustrates heat transfer and sound capturing attributes of the ear pad in FIG. 4;

FIGS. 6-10 illustrate various examples of lattices that can be used;

FIG. 11 illustrates example logic in example flow chart format of manufacturing a 3D printed ear pad;

FIG. 12 illustrates a workflow consistent with FIG. 11;

FIG. 13 illustrates further details of a workflow; and

FIG. 14 illustrates a 3D printing system.

### DETAILED DESCRIPTION

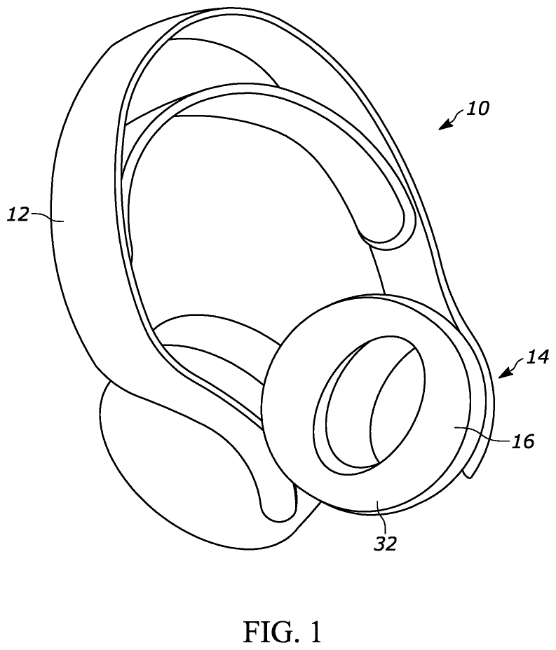

Now referring to FIG. 1, a head-worn apparatus is shown, generally designated 10, configured in the example illustrated as a headset or headphone with a head band 12 supporting left and right speaker assemblies 14, each of which includes at least a speaker and an annular ear pad 16 to cushion against the wearer's face. The speaker assemblies 14 with ear pads 16 preserves sound transmission to the ears while allowing heat to escape from the face, while contouring to the head.

As set forth further below, each ear pad 16 may include a custom designed and generated lattice structure for optimal comfort. By analyzing 3D scans and using pressure mapping measurements, an inventive internal configuration of the ear pad 16 optimizes material performance. This inner structural configuration can be tuned to achieve a desired wear performance in different areas of the ear pad to optimize for comfort. The performance of each segment of this material may be different, unlike current foam ear cups that are all the exact same material with the same behavior all throughout and lack a contoured shape. For example, one part of the ear pad 16 might be extremely soft, while another part is much harder.

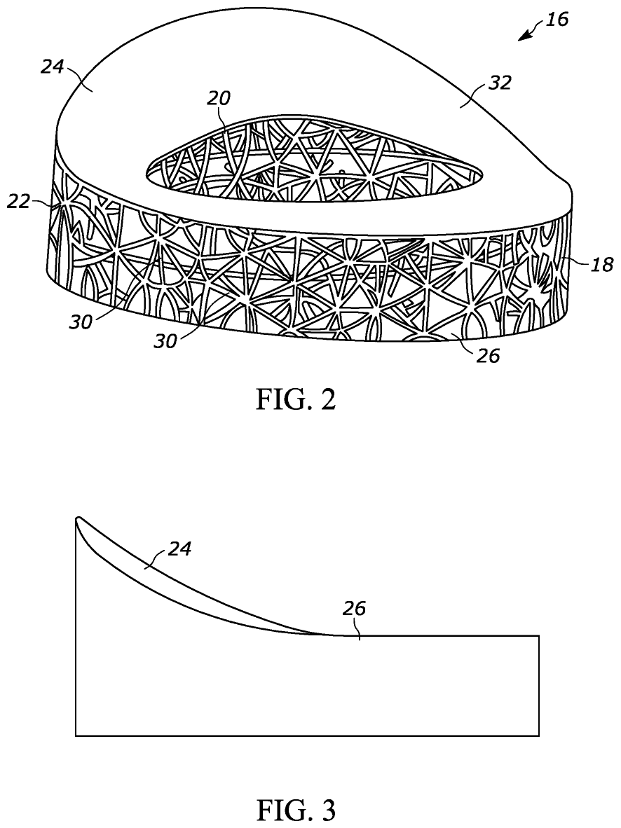

FIG. 2 illustrates an ear pad 16 consistent with present principles which has a body defined by an annular lattice 18. The lattice is annular in that it is formed with a central cylindrical hollow sound passageway 20 to channel sound from the speaker of the speaker assembly to the ear of a wearer. The outer periphery 22 of the lattice also may be round. As set forth elsewhere herein, the lattice may be configured such that the body 18 has a variable resistance to compression from one part of the lattice to another. The variable resistance may be in at least one dimension defined by the lattice, such as the radial dimension defined by the annular lattice, or an axial dimension, or both.

This variable resistance may be achieved by making one part of the lattice less dense (fewer strands or straps/larger lattice openings) and hence less resistive to compression than another part of the lattice. Or a first segment 24 of the ear pad established by the lattice can have a different thickness, e.g., in an axial dimension than a second segment 26. As shown in FIGS. 2 and 3, the first segment 24 can transition smoothly without discontinuities in thickness to the second segment 26. The strands of the lattice may have variable widths such that some strands (e.g., in areas which are desired to be relatively stiffer and thus more resistive to compression) can be thicker than strands in other areas desired to be less stiff and thus less resistive to compression.

FIG. 2 illustrates that the lattice may be an irregular lattice, meaning that its strands 28 form closed perimeters such as triangles that can have different shapes and/or sizes across the lattice.

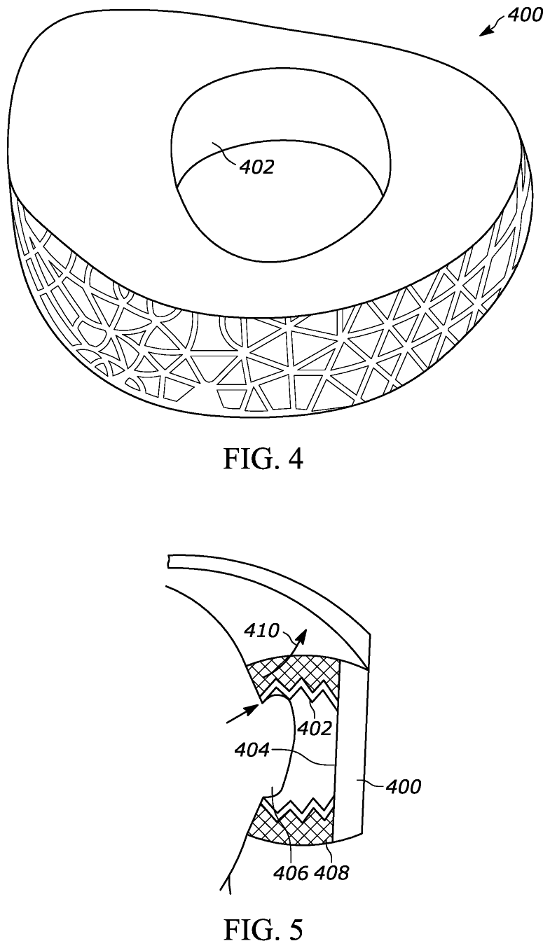

In some embodiments the inner surface of the ear pad 16 may be covered by a continuous skin 32 (FIGS. 1 and 2). The skin 32 may be porous or non-porous. Additionally, while FIG. 2 shows an ear pad in which the annulus 20 formed by the lattice is not covered, FIGS. 4 and 5 show that an ear pad 400 consistent with present principles may include a annulus skin 402 that covers the annulus of the lattice to both add stiffness to the inner part of the ear pad when such is desired and/or to channel sound from the speaker 404 to the ear 406, with heat being allowed to escape from the wearer's body through radially outer portions 408 of the lattice as indicated by the arrow 410.

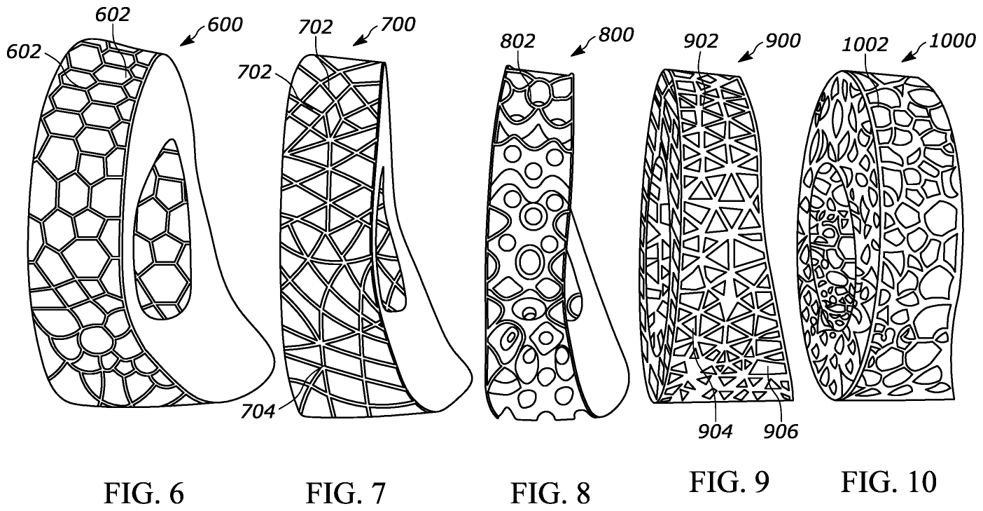

FIGS. 6-10 illustrate various examples of lattices that can be used for an ear pad consistent with present principles. FIG. 6 illustrates a lattice 600 the strands 602 of which form closed perimeters that are hexagonal. The lattice in FIG. 6 is regular in that the hexagons are all approximately equally spaced and of equal size to each other.

FIG. 7 illustrates a lattice 700 in which strands 702 form triangular closed perimeters. Some strands 704 in FIG. 7 form diamond-shaped perimeters.

FIG. 8 illustrates a lattice 800 the strands 802 of which form circular perimeters.

FIG. 9 illustrates a lattice 900 the strands 902 of which form both triangular perimeters 904 and diamond-shaped perimeters 906.

FIG. 10 illustrates a lattice 1000 the strands 1002 of which form various perimeters including octagonal perimeters.

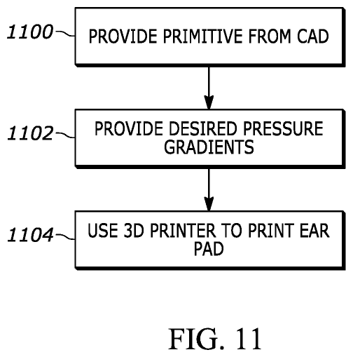

FIG. 11 illustrates further. At block 110 a primitive 3D form is provided from, e.g., computer aided design (CAD) software of a desired contour of an ear pad, such as the contour shown in FIGS. 2 and 3. Moving to block 1102, desired pressure gradients are provided for various parts of the ear pad, with the contour and pressure information being used at block 1104 to produce a lattice-based ear pad using 3D printing techniques.

Note that techniques other than 3D printing may be used. For example, injection molding may be used to produce an ear pad consistent with present principles. Or strands of a lattice to form an ear pad may be joined after manufacture of the strands by, e.g., sonic welding, rf sealing, adhesive bonding, etc. The 3D printing technique is thus an example.

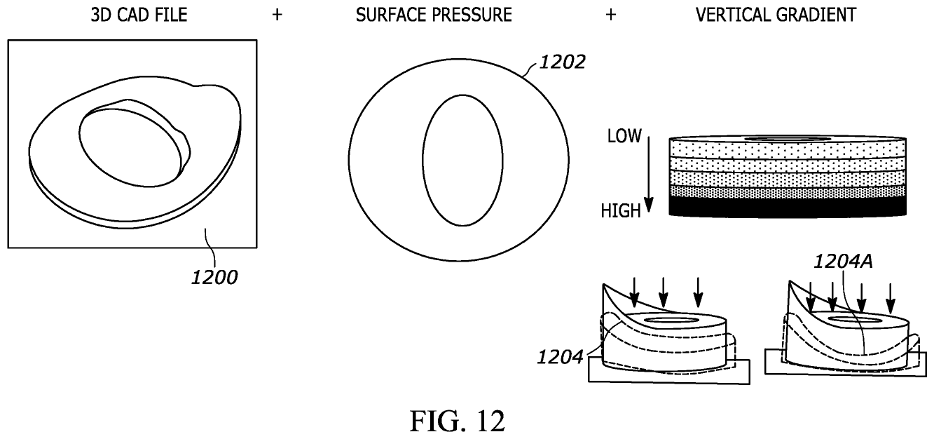

The principles of FIG. 11 are amplified in FIG. 12. A CAD file is produced representing a 3D primitive shape 1200. A desired surface pressure profile 1202 also is produced representing the desired (variable) pressure on the wearer at various portions of the inner surface of the ear pad. Additionally, a vertical pressure gradient profile 1204 is provided (two example vertical pressure gradients 1204, 1204a illustrated as examples). The higher-pressure portions are translated into thicker regions 24 in FIGS. 2 and 3 during 3D printing whereas the lower pressure portions are translated into thinner regions 26.

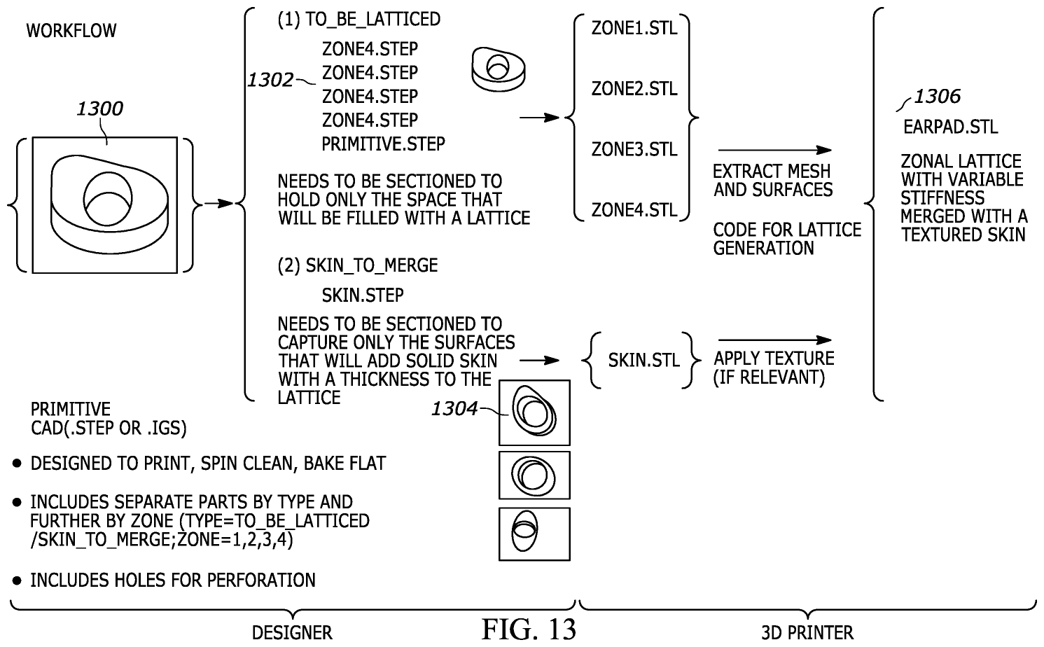

FIG. 13 continues the explanation. Designer steps typically include producing the 3D primitive 1300 for 3D printing, spin clean, and bake flat processes. Lattice characteristics in terms of resistance to compression may be produced region 1302 by region of the ear pad. Surfaces of the lattice to be covered by a solid skin are designated at 1304. This data is then provided to the 3D printer which extracts the desired mesh and skin surfaces and any desired surface textures to produce at 1306 a zonal lattice with variable stiffness merged with the demanded textured skin portions.

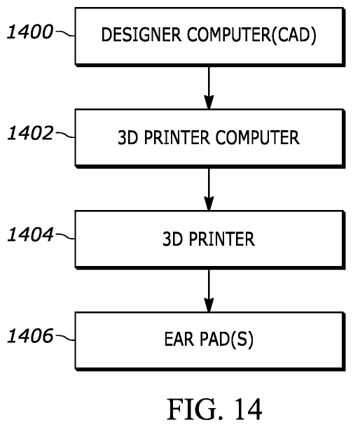

FIG. 14 illustrates that the above may be implemented by a designer computer 1400 producing CAD primitives and other information discussed herein, which is provided to a 3D printer computer 1402. The 3D printer computer 1402 controls a 3D print apparatus 1404 to produce the ear pads 1406 described herein.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

It will be appreciated that whilst present principals have been described with reference to some example embodiments, these are not intended to be limiting, and that various alternative arrangements may be used to implement the subject matter claimed herein.

What is claimed is:

1. A device comprising:
an ear pad for a head-worn apparatus comprising:
an annular lattice establishing a body having a variable resistance to compression in at least one dimension defined by the lattice.

2. The device of claim 1, comprising the head-worn apparatus.

3. The device of claim 1, wherein the at least one dimension comprises a radial dimension defined by the annular lattice.

4. The device of claim 1, wherein the at least one dimension comprises an axial dimension defined by the annular lattice.

5. The device of claim 1, wherein a first segment of the ear pad has a first thickness in an axial dimension and a second segment of the ear pad has a second thickness in the axial dimension.

6. The device of claim 5, wherein the first segment transitions smoothly without discontinuities in thickness to the second segment.

7. The device of claim 1, wherein the lattice is an irregular lattice.

8. The device of claim 1, wherein the lattice is a regular lattice.

9. The device of claim 1, wherein the lattice comprises strands forming closed perimeters.

10. The device of claim 9, wherein a first one of the perimeters defines an opening having a first size and a second one of the perimeters defines an opening having a second size smaller than the first size.

11. The device of claim 9, wherein a first one of the strands has a first width and a second one of the strands has a second width smaller than the first width.

12. The device of claim 1, wherein the body has an inner annular surface, and the device comprises a skin covering the inner annular surface.

13. A method, comprising:
generating a primitive shape of an ear pad using computer aided design (CAD); and
based at least in part on the primitive shape, creating a lattice to establish at least a body of the ear pad.

14. The method of claim 13, further comprising:
receiving a profile of resistance to compression; and
based at least in part on the profile, creating the lattice using the 3D printer.

15. An assembly comprising:
at least one head-worn support; and
left and right ear pads on the support for cushioning a user around ears of the user when the user wears the head-worn support, the ear pads having variable compressive properties.

16. The assembly of claim 15, wherein the ear pads comprise lattices.

17. The assembly of claim 15, wherein the ear pads comprise respective first segments having a first thickness in an axial dimension and respective second segments having a second thickness in the axial dimension, and the respective first segments transition smoothly without discontinuities in thickness to the respective second segments.
